(19) United States
(12) Patent Application Publication
(10) Pub. No.: US 2004/0104988 A1
(43) Pub. Date: Jun. 3, 2004

(54) Image recording method

(75) Inventor: Hidemasa Sawada, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/717,589

(22) Filed: Nov. 21, 2003

(30) Foreign Application Priority Data
Nov. 22, 2002 (JP) 2002-339546

(51) Int. Cl. B41J 2/01

(52) U.S. Cl. 347/101

(57) ABSTRACT

An image recording method, with which an image can be formed with excellent color clarity, color density, fixability, and so forth, and there is no image smearing, has:

a pretreatment step of causing a pretreatment liquid containing dipropylene glycol monopropyl ether and a cationic substance to adhere on a medium; and

a recording step of forming, after the pretreatment step, an image on the medium by using an aqueous pigment ink containing a pigment and resin microparticles having a negative surface charge.

### BACKGROUND OF THE INVENTION

1. Field of the Invention

The present invention relates to an image recording method for forming an image using an ink on a medium such as cloth or paper.

2. Description of the Related Art

Images have been formed in the past by discharging a pigment ink by ink jet or another such method onto a medium such as paper. Along with being coated with the pigment ink, the medium is also sometimes coated with a pretreatment liquid, which is known to improve image quality (see, for example, Japanese Laid-Open Patent Applications 2000-318300 (paragraph number 0070, Example 1, etc.), H11-228898 (paragraph number 0035), and 2002-79740 (starting at paragraph number 0100, Example 1)).

Recently, a wide variety of fashion expressions are demanded in apparel industries, and the ink jet method described above has been used as one of such expression methods. In other words, the ink jet method, in which an image is formed by discharging an ink onto cloth, has been used.

However, because cloth is a fibrous material, it is prone to ink bleeding, so when an image was formed by a conventional method, the ink bled, or most of the discharged ink penetrated into the interior of the cloth, so the amount of pigment fixed on the surface of the cloth ended up being small. This resulted in an indistinct image and pale color density. Furthermore, if the ink discharged onto cloth dries too slowly, a spray of ink that is not yet dry can scatter to other areas and smear the image in the process of image formation.

Moreover, an image formed on cloth could not be fixed satisfactorily, and its colors tended to fade when the cloth was laundered.

In addition, such problems are also seen when using Japanese paper (“washi” in Japanese) containing fibers, as well as using cloth.

### SUMMARY OF THE INVENTION

The present invention was conceived in light of the above points, and it is an object thereof to provide an image recording method with which an image can be formed with excellent color clarity, color density, fixability, and so forth, and there is no image smearing.

The present invention provides an image recording method comprising a pretreatment step of causing a pretreatment liquid containing dipropylene glycol monopropyl ether and a cationic substance to adhere on a medium, and a recording step of forming, after the pretreatment step, an image on the medium by using an aqueous pigment ink containing a pigment and resin microparticles having a negative surface charge.

The present invention also provides an image recording method comprising a pretreatment step of causing a pretreatment liquid containing dipropylene glycol monopropyl ether and a cationic substance to adhere on a medium, a black recording step of forming, after the pretreatment step, an image on the medium by using a black aqueous pigment ink containing a black pigment and resin microparticles having a negative surface charge, and a color recording step of forming, after a specific amount of time has elapsed since the execution of the black recording step, an image on the medium by using a colored aqueous pigment ink containing a pigment other than the black pigment and resin microparticles having a negative surface charge.

### BRIEF DESCRIPTION OF THE DRAWINGS

FIG. 1 is a diagram illustrating the image formed in Example 3.

### DESCRIPTION OF THE PREFERRED EMBODIMENTS

The present invention provides the image recording method which comprises a pretreatment step of causing a pretreatment liquid containing dipropylene glycol monopropyl ether and a cationic substance to adhere on a medium, and a recording step of forming, after the pretreatment step, an image on the medium by using an aqueous pigment ink containing a pigment and resin microparticles having a negative surface charge.

With the image recording method of the present invention, there is no bleeding because the aqueous pigment ink coating applied in the recording step does not bleed into the medium. Also, because the aqueous pigment ink does not bleed, the majority of the pigment stays on the surface of the medium, resulting in excellent color clarity and color density in the image.

The reason for this is believed to be that the aqueous pigment ink is prevented from bleeding into the medium by the dipropylene glycol monopropyl ether contained in the pretreatment liquid, and the resin microparticles in the aqueous pigment ink is hardened by the action of the cationic substance contained in the pretreatment liquid to form a film on the surface of the medium, so that the pigment is held inside this film.

Also, with the image recording method of the present invention, the aqueous pigment ink that coats the medium dries quickly. The reason for this seems to be that, as mentioned above, the action of the cationic substance contained in the pretreatment liquid quickly solidifies the resin microparticles in the aqueous pigment ink and forms a film on the surface of the medium. The result of this rapid drying in the present invention is that the aqueous pigment ink with which the medium has been coated does not bounce as a spray in the course of image formation (using, for example, an ink jet head), and does not adhere anywhere else. In other words, image smearing is unlikely to occur with the image recording method of the present invention.

Also, with the image recording method of the present invention, because of the good fixability of the image, there is no color fading when the medium (such as cloth or paper) is laundered after image formation. The reason for this is believed to be that the pigment is held inside a film composed of resin microparticles.

Further, with the image recording method of the present invention, when the medium is, for example, cloth, paper, or the like, the portion on which the image is formed feels good to the touch.

The image recording method of the present invention also has the effect of enhancing coloring when a colored aqueous pigment ink (such as magenta) is applied, for example. The phrase “enhancing coloring” as used here means, for example, increasing the numerical value of c* in the following formula in the measurement of the L*a*b* value by colorimetry.

c*=((a*)²+(b*)²)^{1/2}

From the standpoint of preventing the aqueous pigment ink from bleeding into the medium, the amount of dipropylene glycol monopropyl ether contained in the pretreatment liquid is preferably between 5 and 10 wt %.

Examples of the above-mentioned cationic substance include cationic surfactants, and specific examples include coconut amine, hardened beef tallow amine, and other such higher alkylamine salt-type cationic surfactants, dihydroxyethylstearylamine and other such higher alkylamine ethylene oxide adducts, Soromine A-type cationic surfactants, Sapamine A-type cationic surfactants, Arcobel A-type cationic surfactants, imidazoline-type cationic surfactants, lauryltrimethylammonium chloride, lauryldimethylbenzylammonium chloride, Sapamine Miss., Sapamine BCH, Catanac SN, Zelan AP, and other such quaternary ammonium salt-type cationic surfactants, and cationic polymer coagulants. When irritation of the skin is taken into account, this cationic substance may be contained preferably in an amount between 0.01 and 10 wt %.

Examples of the above-mentioned pigment include surface treated carbon black, surface treated yellow pigment (Pigment Yellow 169), surface treated magenta pigment (Pigment Red 122), and surface treated cyan pigment (Pigment Blue 15:3). From the standpoints of maintaining good dispersibility in the ink, good reproduction of color density, and moderating interaction with other components, this pigment may be contained preferably in an amount between 0.5 and 15 wt %. The average volumetric particle size of the pigment may be preferably between 100 nm and 5 μm.

Examples of the above-mentioned resin microparticles having a negative surface charge include resin emulsions, specific examples of which include acrylic resin, urethane resin, polyester resin, polyethylene resin, polystyrene resin, vinyl acetate resin, ethylene/vinyl acetate resin, polyvinyl alcohol resin, styrene/acrylic resin, acrylic ester resin, vinyl acetate/acrylic resin, ethylene/vinyl acetate/acrylic resin, chlorinated polyolefin resin, and silicone resin. From the standpoints of maintaining good dispersibility in the ink, aiding good reproduction of color density, and moderating interaction with other components, these resin microparticles having a negative surface charge may be contained preferably in an amount between 1 and 73 wt %. The average volumetric particle size of the resin microparticles having a negative surface charge may be preferably between 10 and 100 nm (and more preferably 10 to 50 nm) so that the resin microparticles will gather together more readily, which accelerates the curing of the aqueous pigment ink.

In the above-mentioned pretreatment step and/or the recording step, the pretreatment liquid or the aqueous pigment ink can be applied using, for example, an ink jet printer.

The present invention also provides an image recording method which comprises a pretreatment step of causing a pretreatment liquid containing dipropylene glycol monopropyl ether and a cationic substance to adhere on a medium, a black recording step of forming, after the pretreatment step, an image on the medium by using a black aqueous pigment ink containing a black pigment and resin microparticles having a negative surface charge, and a color recording step of forming, after a specific amount of time has elapsed since the execution of the black recording step, an image on the medium by using a colored aqueous pigment ink containing a pigment other than the black pigment and resin microparticles having a negative surface charge.

The image formed in the black recording step and the image formed in the color recording step in the present invention are the same as the image formed in the above-mentioned present invention in that there is no bleeding, the color clarity and color density of the image are excellent, image smearing is unlikely to occur, there is no color fading as a result of laundering, and the printed material feels good to the touch. Also, the image formed in the color recording step is characterized by excellent coloring.

The above-mentioned “specific amount of time” refers to the time it takes for the substances in the treatment liquid to react with the substances in the ink. This specific amount of time is one second, for example.

In the image recording method of the present invention, the resin microparticles are preferably a resin emulsion.

When the resin microparticles are a resin emulsion, density is easier to be adjusted, the desired laundering fastness is easier to be achieved, and the printing on the printed material feels better to the touch.

In the image recording method of the present invention, the average size of the resin microparticles is preferably smaller than the average particle size of the pigment.

When the average size of the resin microparticles is smaller than the average particle size of the pigment, there is less interaction caused by the mixing of a complex dispersion system in the ink, and good dispersibility can be maintained.

The above-mentioned “average particle size” refers to the volumetric average particle size measured using an apparatus based on the measurement principle of dynamic light scattering.

In the image recording method of the present invention, the medium is preferably a cloth.

When the medium is a cloth, an image with excellent color clarity, color density, and fixability, and with little image smearing or the like, can be formed on clothing and so forth.

### EXAMPLES

The image recording method of the present invention will now be described by referring to the following Examples.

In these Examples, cloth, rather than paper, was used as the medium.

### EXAMPLE 1

a) First, a pretreatment liquid was prepared by mixing the following components.

| Components | wt % |
|---|---|
| Dipropylene glycol monopropyl ether | 5 |
| SHALLOL DC-902P | 1 |
| (trade name of a cationic substance made by Dai-ichi | |
| Kogyo Seiyaku) | |
| Surface treated silica | 2 |
| Water | balance |

b) Next, an aqueous pigment ink (black aqueous pigment ink) was prepared by mixing the following components.

| Components | wt % |
|---|---|
| Surface treated carbon black (black pigment) | 5 |
| Acrylic resin emulsion | 5 |
| (resin microparticles having a negative surface charge) | |
| Diethanolamine | 1 |
| Water | balance |

c) There will be now described how image recording was performed using a pretreatment liquid and an aqueous pigment ink.

First, a cloth (100% cotton) was uniformly coated with the pretreatment liquid prepared in a) above, in an amount of 0.0216 g/inch², using a piezo-type ink jet printer with a resolution of 600 dpi.

Next, the portion coated with the pretreatment liquid was further coated with the black aqueous pigment ink prepared in b) above, so as to form a black circle with a diameter of 2 cm, using the above-mentioned ink jet printer. The coating amount of black aqueous pigment ink here was 0.01476 g/inch².

A hot press was then used to heat the portion with the above-mentioned black circle for 30 seconds at 180° C. to fix the ink.

d) The effects of the image recording method in Example 1 will now be described.

(1) With the image recording method of Example 1, the aqueous pigment ink does not penetrate into the cloth, so there is no bleeding. Also, since there is no penetration of the aqueous pigment ink, most of the pigment stays on the surface of the cloth, resulting in an image with excellent color clarity and color density.

(2) With the image recording method of Example 1, because the aqueous pigment ink applied to the cloth dried quickly, once the cloth was coated with the aqueous pigment ink, the ink does not bounce as a spray (using, for example, an ink jet head) and adhere anywhere else. In other words, image smearing is unlikely to occur with the image recording method of Example 1.

(3) With the image recording method of Example 1, because the image had good fixability, there was no color fading when the cloth was laundered.

(4) With the image recording method of Example 1, the portion where the image is formed feels good to the touch.

e) An experiment conducted to confirm the characteristics of the image recording method of the present invention will now be described.

The reflection density of the portion where a black circle was formed in d) above was measured with an RD-914 reflection densitometer made by Macbeth.

TABLE 1

| | Reflection |
|---|---|
| | density |
| Example 1 | 1.51 |
| Comparative Example 1 | 1.35 |
| Comparative Example 2 | 1.38 |
| Comparative Example 3 | 1.32 |

As shown in Table 1, the portion coated with black aqueous pigment ink exhibits a high reflection density of 1.51, which indicates a high black density value.

### EXAMPLE 2

a) A pretreatment liquid was manufactured in the same manner as in Example 1 above. Also, a magenta aqueous pigment ink (colored aqueous pigment ink) was manufactured by mixing the following components.

| Components | wt % |
|---|---|
| Surface treated magenta pigment | 2 |
| (Pigment Red 122) | |
| Acrylic resin emulsion | 5 |
| (resin microparticles having a negative surface charge) | |
| Glycerol | 15 |
| Diethanolamine | 1 |
| Water | balance |

b) In the same manner as in Example 1 above, a cloth (100% cotton) was uniformly coated with the pretreatment liquid in an amount of 0.0208 g/inch² using an ink jet printer, after which the magenta aqueous pigment ink prepared in a) above was used to form a circle 2 cm in diameter over the portion coated with the pretreatment liquid. The coating amount of magenta aqueous pigment ink here was 0.0162 g/inch². Next, the portion coated with the magenta aqueous pigment was heated with a hot press for 30 seconds at 180° C. to fix the ink.

c) The effects of the image recording method in Example 2 will now be described.

The image recording method of Example 2 has the same effects as those of Example 1.

Furthermore, the image recording method of Example 2 has the effect of enhancing magenta coloring.

d) An experiment conducted to confirm the effect of enhancing magenta coloring described in c) above will now be described.

A colorimeter (available from Konica Minolta Holdings, INC.) was used to measure the color of the portion coated with the magenta aqueous pigment in b) above, the results of which are given in Table 2.

TABLE 2

| | Color tone | | |
|---|---|---|---|
| | L* | a* | b* |
| Example 2 | 57.43 | 56.81 | −8.95 |
| Comparative Example 4 | 56.20 | 51.67 | −7.50 |
| Comparative Example 5 | 56.94 | 50.31 | −6.84 |
| Comparative Example 6 | 57.55 | 47.54 | −7.4 |

As shown in Table 2, the a* and b* values among L*, a* and b* values for the portion coated with the magenta aqueous pigment were clearly higher with Example 2 than with the comparative examples, and the range of color that could be expressed was definitely wider, so the pretreatment liquid clearly enhances color expression.

### EXAMPLE 3

a) A pretreatment liquid and a black aqueous pigment ink were manufactured in the same manner as in Example 1 above. Also, a yellow aqueous pigment ink (colored aqueous pigment ink) was manufactured by mixing the following components.

| Components | wt % |
|---|---|
| surface treated yellow pigment | 2 |
| (Pigment Yellow 169) | |
| Acrylic resin emulsion | 5 |
| (resin microparticles having a negative surface charge) | |
| Glycerol | 15 |
| Diethanolamine | 1 |
| Water | balance |

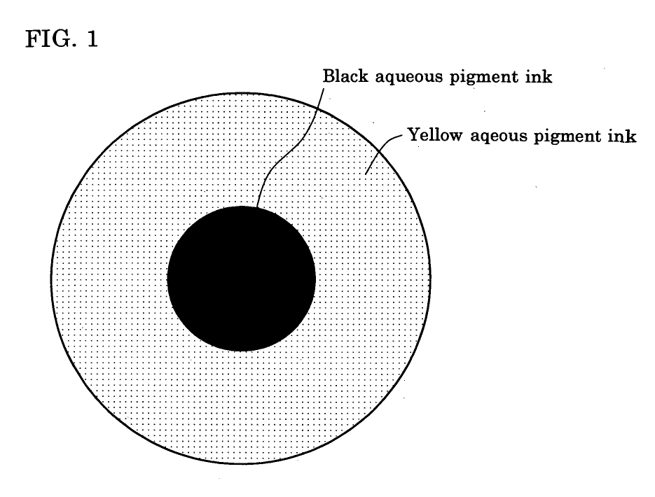

b) The image recording method of Example 3 will now be described through reference to FIG. 1.

First, in the same manner as in Example 1 above, a cloth (100% cotton) was uniformly coated with the pretreatment liquid in an amount of 0.0211 g/inch² using an ink jet printer. Immediately after this, the black aqueous pigment ink prepared in a) above was used to form a circle 2 cm in diameter, again with an ink jet printer, over the portion coated with the pretreatment liquid. The coating amount of black aqueous pigment ink here was 0.0156 g/inch².

One second after completion of the application of the black aqueous pigment ink, the yellow aqueous pigment ink manufactured in a) above was applied around the outside of the above-mentioned black circle by solid printing with an ink jet printer. The coating amount of yellow aqueous pigment ink here was 0.0147 g/inch².

c) The effects of the image recording method in Example 3 will now be described.

The image recording method of Example 3 has the same effects as those of Example 1.

Also, with the image recording method of Example 3, since the yellow aqueous pigment ink is applied one second (the specific amount of time) after completion of the application of the black aqueous pigment ink, there is no smearing of the image. The reason for this is believed to be that since the black aqueous pigment ink is fixed by the action of the pretreatment liquid in one second, when the ink jet head passes over the black circle portion in the course of applying the yellow aqueous pigment ink, the ink jet head does not scatter the black aqueous pigment ink and send up a spray thereof that would adhere to areas outside of the black circle.

d) Next, the smearing of the image formed by the image recording method of Example 3 was evaluated, the results of which are given below.

A visual count was made of the number of black particles produced by the scattering of black aqueous pigment ink around the black circle (the area coated with the yellow aqueous pigment ink) in the image formed in c) above. These results are given in Table 3.

TABLE 3

| | | Time between | Number of |
|---|---|---|---|
| | Pretreatment | black and yellow | black ink |
| | step | printing (sec) | particles |
| Example 3 | yes | 1 | 2 |
| Example 4 | yes | 5 | 0 |
| Comparative Ex. 7 | no | 5 | 30 |
| Example 1 | yes | 0 | 20 |
| Example 2 | yes | 0.5 | 10 |

As shown in Table 3, there were only two black particles in Example 3, confirming that there is less image smearing.

### EXAMPLE 4

An image consisting of a black circle and a yellow area around the outside of this black circle was formed basically in the same manner as in Example 3 above. In Example 4, however, the yellow aqueous pigment ink was applied 5 seconds after the completion of the application of the black aqueous pigment ink.

The image recording method of Example 4 has the same effects as that of Example 3, in addition to which, image smearing is even less likely to occur because the time between the completion of the application of the black aqueous pigment ink and the application of the yellow aqueous pigment ink is longer than in Example 3.

The extent of smearing of the image formed by the image recording method of Example 4 was evaluated in the same manner as in d) of Example 3 above, the results of which are given in Table 3 above. As seen in Table 3, with the image formed in Example 4, the number of black particles was zero, confirming that image smearing is even less likely to occur.

### COMPARATIVE EXAMPLE 1

A pretreatment liquid was manufactured by mixing the following components.

| Components | wt % |
|---|---|
| Propylene glycol monopropyl ether | 5 |
| SHALLOL DC-902P (cationic substance) | 1 |
| Surface treated silica | 2 |
| Water | balance |

A black aqueous pigment ink was also manufactured in the same manner as in Example 1.

An image of a black circle was formed in the same manner as in c) of Example 1 above by using this pretreatment liquid and black aqueous pigment ink. The density of the portion comprising this black circle was measured in the same manner as in e) of Example 1 above, the results of which are given in Table 1. As shown in Table 1, the reflection density was 1.35, far lower than the value obtained in Example 1.

This Comparative Example 1 is an example of being outside the scope of the present invention, as the pretreatment liquid contains no dipropylene glycol monopropyl ether.

### COMPARATIVE EXAMPLE 2

A pretreatment liquid was manufactured by mixing the following components.

| Components | wt % |
|---|---|
| Dipropylene glycol monobutyl ether | 5 |
| SHALLOL DC-902P (cationic substance) | 1 |
| Surface treated silica | 2 |
| Water | balance |

A black aqueous pigment ink was also manufactured in the same manner as in Example 1.

An image of a black circle was formed in the same manner as in c) of Example 1 above by using this pretreatment liquid and black aqueous pigment ink. The density of the portion comprising this black circle was measured in the same manner as in e) of Example 1 above, the results of which are given in Table 1. As shown in Table 1, the reflection density was 1.38, far lower than the value obtained in Example 1. In other words, the image formed in Comparative Example 2 was thin in density.

This Comparative Example 2 is an example of being outside the scope of the present invention, as the pretreatment liquid contains no dipropylene glycol monopropyl ether.

### COMPARATIVE EXAMPLE 3

A pretreatment liquid was manufactured by mixing the following components.

| Components | wt % |
|---|---|
| Dipropylene glycol methyl ether | 5 |
| SHALLOL DC-902P (cationic substance) | 1 |
| Surface treated silica | 2 |
| Water | balance |

A black aqueous pigment ink was also manufactured in the same manner as in Example 1.

An image of a black circle was formed in the same manner as in c) of Example 1 above by using this pretreatment liquid and black aqueous pigment ink. The density of the portion comprising this black circle was measured in the same manner as in e) of Example 1 above, the results of which are given in Table 1. As shown in Table 1, the reflection density was 1.32, far lower than the value obtained in Example 1. In other words, the image formed in Comparative Example 3 was low in density.

This Comparative Example 3^{[3]} is an example of being outside the scope of the present invention, as the pretreatment liquid contains no dipropylene glycol monopropyl ether.

### COMPARATIVE EXAMPLE 4

A pretreatment liquid was manufactured in the same manner as in Comparative Example 1 above. A magenta aqueous pigment ink was manufactured in the same manner as in Example 2 above.

This pretreatment liquid and magenta aqueous pigment ink were used to form an image consisting of a circle 2 cm in diameter in the same manner as in b) of Example 2 above. The color of the portion consisting of this circle was then measured in the same manner as in d) of Example 2 above. The results are given in Table 2 above. As seen in Table 2, the a* and b* values among L*, a* and b* values for the image formed in Comparative Example 4 were clearly lower than those in Example 2, and the range of color that could be expressed was narrower, so the color tone of the magenta color was inferior.

This Comparative Example 4 is an example of being outside the scope of the present invention, as the pretreatment liquid contains no dipropylene glycol monopropyl ether.

### COMPARATIVE EXAMPLE 5

A pretreatment liquid was manufactured in the same manner as in Comparative Example 2 above. A magenta aqueous pigment ink was manufactured in the same manner as in Example 2 above.

This pretreatment liquid and magenta aqueous pigment ink were used to form an image consisting of a circle 2 cm in diameter in the same manner: as in b) of Example 2 above. The color of the portion consisting of this circle was then measured in the same manner as in d) of Example 2 above. The results are given in Table 2 above. As seen in Table 2, the a* and b* values among L*, a* and b* values for the image formed in Comparative Example 5 were clearly lower than those in Example 2, and the range of color that could be expressed was narrower, so the color tone of the magenta color was inferior.

This Comparative Example 5 is an example of being outside the scope of the present invention, as the pretreatment liquid contains no dipropylene glycol monopropyl ether.

### COMPARATIVE EXAMPLE 6

A pretreatment liquid was manufactured in the same manner as in Comparative Example 3 above. A magenta aqueous pigment ink was manufactured in the same manner as in Example 2 above.

This pretreatment liquid and magenta aqueous pigment ink were used to form an image consisting of a circle 2 cm in diameter in the same manner as in b) of Example 2 above. The color of the portion consisting of this circle was then measured in the same manner as in d) of Example 2 above. The results are given in Table 2 above. As seen in Table 2, the a* and b* values among L*, a* and b* values for the image formed in Comparative Example 6 were clearly lower than those in Example 2, and the range of color that could be expressed was narrower, so the color tone of the magenta color was inferior.

This Comparative Example 6^{[} is an example of being outside the scope of the present invention, as the pretreatment liquid contains no dipropylene glycol monopropyl ether.

### COMPARATIVE EXAMPLE 7

A black circle was formed, and 5 seconds later the area around the outside of this black circle was coated with a yellow aqueous pigment ink to form an image in basically the same manner as in Example 4 above. In Comparative Example 7, however, no pretreatment liquid was used, and the cloth was coated directly with the black aqueous pigment ink and yellow aqueous pigment ink. This Comparative Example 7 is an example of being outside the scope of the present invention since it includes no pretreatment step.

The extent of smearing of the image formed by the image recording method of Comparative Example 7 was evaluated in the same manner as in d) of Example 3 above, the results of which are given in Table 3 above. As seen in Table 3, with the image formed in Comparative Example 7, the number of black particles was 30, and image smearing was severe.

Experiment 1

An image consisting of a black circle and a yellow area around the outside of this black circle was formed basically in the same manner as in Example 3 above. In this Experiment Example 1, however, the yellow aqueous pigment ink was applied immediately upon completion of the application of the black aqueous pigment ink.

The extent of smearing of the image formed by the image recording method of Experiment 1 was evaluated in the same manner as in d) of Example 3 above, the results of which are given in Table 3 above. As seen in Table 3, with the image formed in Experiment Example 1, the number of black particles was 20.

Experiment 2

An image consisting of a black circle and a yellow area around the outside of this black circle was formed basically in the same manner as in Example 3 above. In this Experiment 2, however, the yellow aqueous pigment ink was applied 0.5 second after the completion of the application of the black aqueous pigment ink.

The extent of smearing of the image formed by the image recording method of Experiment 2 was evaluated in the same manner as in d) of Example 3 above, the results of which are given in Table 3 above. As seen in Table 3, with the image formed in Experiment 2, the number of black particles was 10.

The present invention is not limited to Examples given above, and it may go without saying that the present invention can be worked in various aspects within the scope thereof.

For instance, cloth was used as the medium in these embodiments, but the same effects as in Examples 1 to 4 can be confirmed using Japanese paper (“washi” in Japanese) or other such paper.

The entire disclosure of the specification, claims, abstract and drawings of Japanese Patent Application No. 2002-339546 filed on Nov. 22, 2002 is hereby incorporated by reference.

What is claimed is:

1. An image recording method, comprising:
a pretreatment step of causing a pretreatment liquid containing dipropylene glycol monopropyl ether and a cationic substance to adhere on a medium; and
a recording step of forming, after the pretreatment step, an image on the medium by using an aqueous pigment ink containing a pigment and resin microparticles having a negative surface charge.

2. An image recording method, comprising:
a pretreatment step of causing a pretreatment liquid containing dipropylene glycol monopropyl ether and a cationic substance to adhere on a medium; and
a black recording step of forming, after the pretreatment step, an image on the medium by using a black aqueous pigment ink containing a black pigment and resin microparticles having a negative surface charge; and
a color recording step of forming, after a specific amount of time has elapsed since the execution of the black recording step, an image on the medium by using a colored aqueous pigment ink containing a pigment other than the black pigment and resin microparticles having a negative surface charge.

3. The image recording method according to claim 1 or 2, wherein the resin microparticles are a resin emulsion.

4. The image recording method according to any of claims 1 or 2, wherein the average size of the resin microparticles is smaller than the average particle size of the pigment.

5. The image recording method according to any of claims 1 or 2, wherein the medium is a cloth.

6. The image recording method according to claim 1 or 2, wherein pretreatment liquid contains dipropylene glycol monopropyl ether in an amount of 5 to 10 wt % and the cationic substance in an amount of 0.01 to 10 wt %.

7. The image recording method according to claim 1 or 2, wherein the aqueous pigment ink contains, in amount of 0.5 to 15 wt %, the pigment which has an average of volume particle size of 10 to 100 nm.
